(19) United States
(12) Patent Application Publication
(10) Pub. No.: US 2021/0187716 A1
(43) Pub. Date: Jun. 24, 2021

(54) DRIVING-IN DEVICE

(71) Applicant: HILTI AKTIENGESELLSCHAFT, Schaan (LI)

(72) Inventors: Stefan MIESCHER, Schaan (LI); Daniele SCHOBER, Eschen (LI)

(21) Appl. No.: 16/769,412

(22) PCT Filed: Nov. 21, 2018
(86) PCT No.: PCT/EP2018/082113

§ 371 Date: Jun. 3, 2020

(30) Foreign Application Priority Data
Dec. 21, 2017 (EP) 17209286.8

(51) Int. Cl. B25C 1/18; B25C 1/00

(52) U.S. Cl. CPC B25C 1/184; B25C 1/005

(57) ABSTRACT

An apparatus for driving fastening elements into an underlying surface has a setting duct, an energy transmission element, movable in a fastening direction in the setting duct, for transmitting energy to each of the fastening elements, and a magazine, having a transport duct for transporting the fastening elements in a transporting direction to the setting duct, wherein the magazine comprises a slider, displaceable in the transporting direction along the transport duct and has a feeding element, movable between a transporting position and a passage position, wherein the feeding element projects into the transport duct in the transporting position to apply a force in the transporting direction to the fastening elements, wherein the feeding element opens the transport duct for the fastening elements in the passage position, and wherein the slider has a release spring, the feeding element toward the passage position and is supported on the slider.

### TECHNICAL FIELD

The application relates to an apparatus for driving fastening elements into an underlying surface.

### BACKGROUND OF THE INVENTION

Driving-in apparatuses usually have a piston, which is movable in a setting duct, for transmitting energy to the fastening element. The energy required for this has to be made available in a very short time, which is why, for example in the case of what are known as spring nailers, first of all a spring is tensioned, said spring, during the driving-in operation, imparting the tensile energy to the piston in a sudden burst and accelerating the latter onto the fastening element. Further possible drives for the piston are based on a flywheel, on compressed air or on the combustion of solid or gaseous fuel in a combustion chamber. Furthermore, such driving-in apparatuses usually have a magazine for transporting the fastening elements to the setting duct.

The fastening elements are usually made available in the form of strips, wherein such a strip comprises receptacles for the fastening elements, which are arranged in a row. The receptacles of a strip are connected together by means of connecting webs. For transporting the fastening elements, a force toward the setting duct is applied to the strip in the magazine by a feeding element. It is an object of the invention to simplify the transport of the fastening elements.

### SUMMARY OF THE INVENTION

The object is achieved by an apparatus for driving fastening elements into an underlying surface, having a setting duct, an energy transmission element, which is movable in a fastening direction in the setting duct, for transmitting energy to in each case one of the fastening elements, and having a magazine, which has a transport duct for transporting the fastening elements in a transporting direction to the setting duct, wherein the magazine comprises a slider, which is displaceable in the transporting direction along the transport duct and has a feeding element, which is movable between a transporting position and a passage position, wherein the feeding element projects into the transport duct in the transporting position in order to apply a force in the transporting direction to the fastening elements and opens up the transport duct for the fastening elements in the passage position, and wherein the slider has a release spring, which urges the feeding element toward the passage position and is supported on the slider. As a result, any sliding of the release spring on the magazine, in particular in the transport duct, is avoided, and so frictional resistance during the transport of the fastening elements in the transport duct is reduced.

An advantageous embodiment is characterized in that the slider has a latching receptacle, in which the feeding element latches when it is arranged in the transporting position. Preferably, the slider has a latching spring, which urges the feeding element into the latching receptacle. Particularly preferably, the latching spring is supported on the slider.

An advantageous embodiment is characterized in that the slider has an engagement lever, by means of which the feeding element is shiftable, for example manually, from the passage position into the transporting position. Preferably, the feeding element is in this case shiftable counter to a force of the release spring. The engagement lever is preferably connected rigidly to the feeding element.

An advantageous embodiment is characterized in that the slider has an actuating element, by means of which the slider is shiftable manually counter to the transporting direction.

An advantageous embodiment is characterized in that the slider has a stop element, by means of which the feeding element is shiftable, for example manually, out of the latching receptacle. Preferably, the feeding element is in this case shiftable counter to a force of the latching spring. The stop element is preferably connected rigidly to the feeding element. Preferably, the magazine comprises an end region remote from the setting duct, said end region comprising a stop for the stop element. Particularly preferably, the magazine has an end wall in the end region, said end wall forming the stop.

An advantageous embodiment is characterized in that the feeding element is pivotable about a pivot axis between the transporting position and the passage position. A further advantageous embodiment is characterized in that the feeding element is displaceable linearly between the transporting position and the passage position.

An advantageous embodiment is characterized in that the transport duct opens into the setting duct by way of a mouth. A further advantageous embodiment is characterized in that the apparatus, in particular the magazine, has a feeding spring, which applies a force toward the setting duct to the feeding element.

### EMBODIMENTS OF THE INVENTION

Embodiments of an apparatus for driving a fastening element into an underlying surface are explained in more detail in the following text by way of examples and with reference to the drawings, in which:

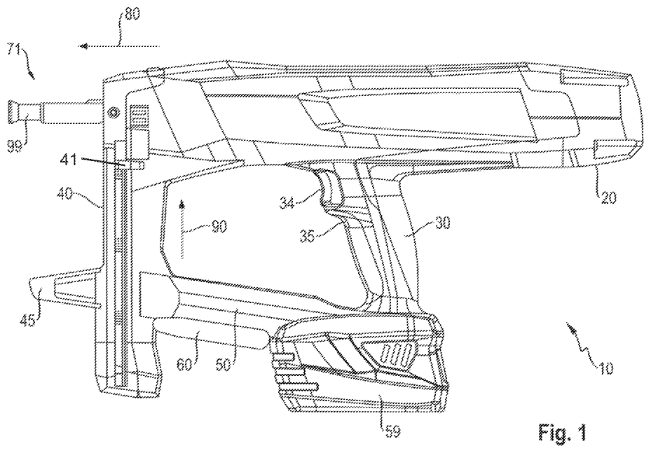

FIG. 1 shows a side view of a driving-in apparatus,

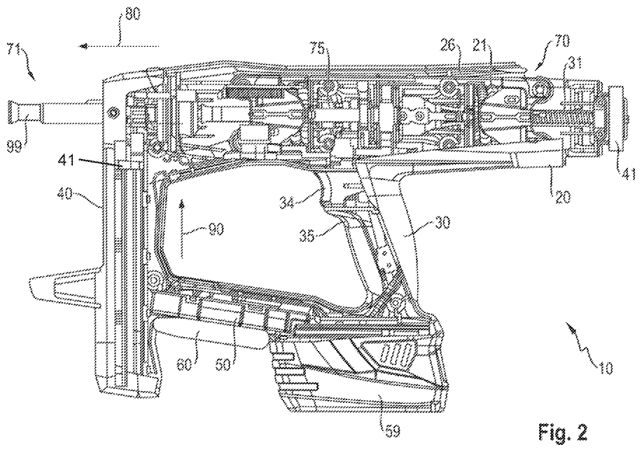

FIG. 2 shows a side view of a driving-in apparatus with the housing open,

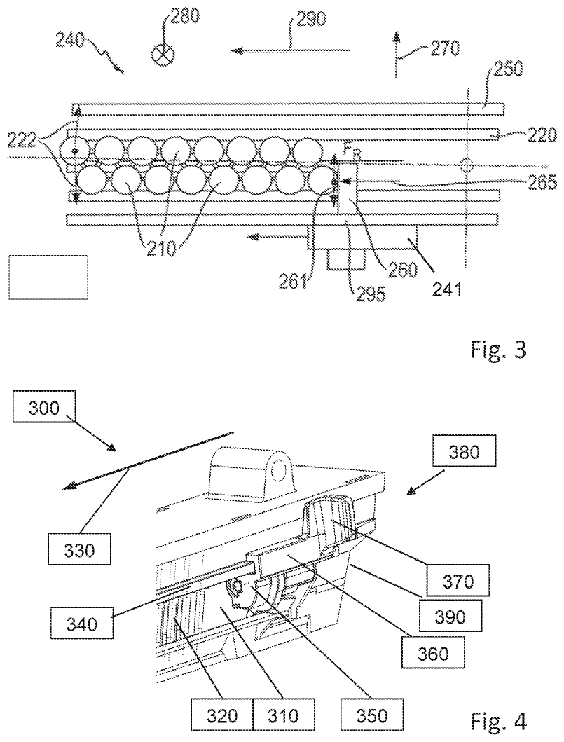

FIG. 3 shows a top view of a magazine,

FIG. 4 shows part of a magazine,

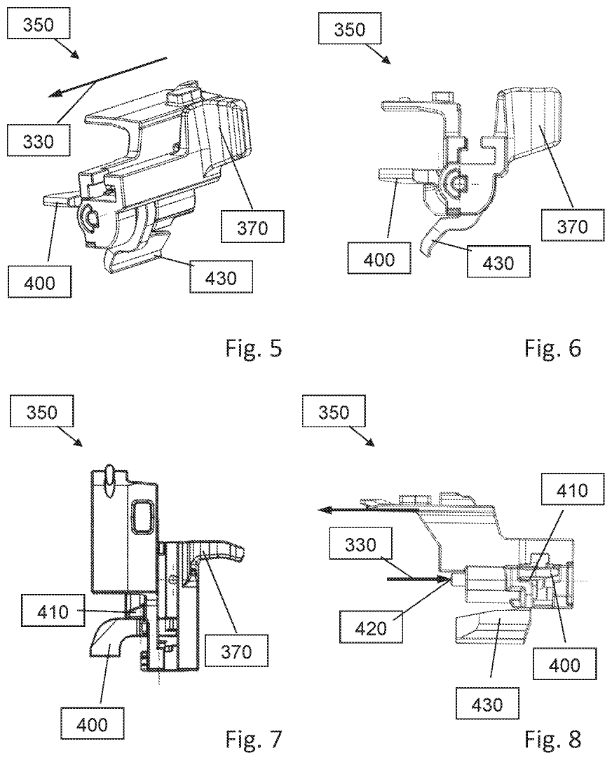

FIG. 5 shows a perspective view of a slider in a transporting position,

FIG. 6 shows a front view of the slider from FIG. 5 in the transporting position,

FIG. 7 shows a plan view of the slider from FIG. 5 in the transporting position,

FIG. 8 shows a side view of the slider from FIG. 5 in the transporting position,

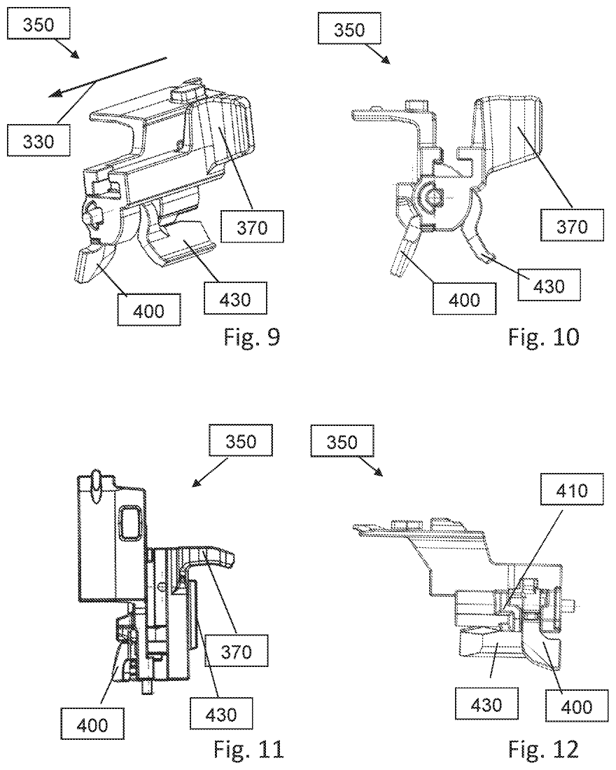

FIG. 9 shows a perspective view of the slider from FIG. 5 in a passage position,

FIG. 10 shows a front view of the slider from FIG. 5 in the passage position,

FIG. 11 shows a plan view of the slider from FIG. 5 in the passage position,

FIG. 12 shows a side view of the slider from FIG. 5 in the passage position, and

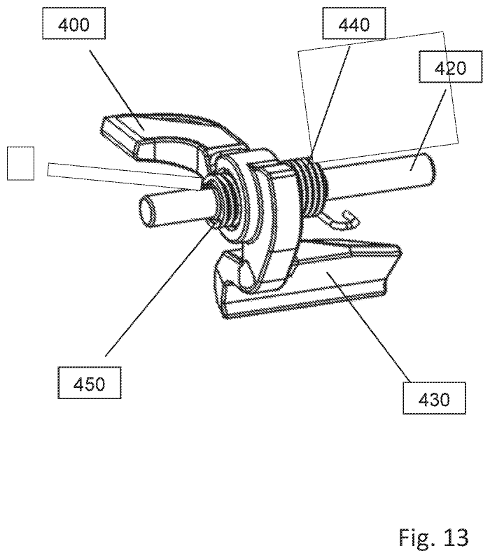

FIG. 13 shows a perspective view of a feeding element.

FIG. 1 shows a side view of a driving-in apparatus 10 for driving a fastening element, for example a nail or bolt, into an underlying surface (not illustrated). The driving-in apparatus 10 has an energy transmission element (not illustrated) for transmitting energy to the fastening element, and a housing 20, in which the energy transmission element and a drive device (likewise not illustrated) for advancing the energy transmission element are received.

The driving-in apparatus 10 also has a handle 30, a magazine 40 and a bridge 50 connecting the handle 30 to the magazine 40. The magazine is not removable and has a slider 41. Fastened to the bridge 50 are a scaffold hook 60 for hanging the driving-in apparatus 10 on a scaffold or the like, and an electrical energy store in the form of a rechargeable battery 59. Arranged on the handle 30 are a trigger 34 and a grip sensor in the form of a manual switch 35. Alignment of the driving-in apparatus perpendicularly to an underlying surface is assisted by an alignment aid 45.

Furthermore, the driving-in apparatus 10 has a setting duct 99 for guiding the fastening element and a pressing device 71 for identifying a distance of the driving-in apparatus 10 from an underlying surface (not illustrated). For this purpose, the pressing device 71 comprises a pressing element, which is shifted with respect to the magazine 40 when the driving-in apparatus 10 is pressed against the underlying surface. The pressing element is formed by the setting duct 99. In exemplary embodiments that are not shown, the pressing element is arranged next to the setting duct and protrudes beyond the latter in the direction of the underlying surface in the non-pressed state. The magazine 40 serves to transport fastening elements to the setting duct 99 in a transporting direction 90 by means of the slider 41.

FIG. 2 shows the driving-in apparatus 10 with the housing 20 open. Received in the housing 20 is a drive device 70 for advancing an energy transmission element 75 that is partially concealed in the drawing. The energy transmission element 75 is moved in a fastening direction 80 in order to transmit energy to in each case one fastening element that is transported into the setting duct 99 from the magazine 40.

The drive device 70 comprises an electric motor (not illustrated) for converting electrical energy from the rechargeable battery 59 into rotational energy, a torque transmission device, comprising a gear mechanism 41, for transmitting a torque of the electric motor to a motion converter in the form of a spindle drive 31, a force transmission device, comprising a roller train 26, for transmitting a force from the motion converter to a mechanical energy store in the form of a spring 21 and for transmitting a force from the spring to the energy transmission element. In exemplary embodiments that are not shown, the drive device is operated by means of a flywheel, compressed air, gas combustion or powder combustion in order to advance the energy transmission element.

FIG. 3 illustrates a plan view of part of a magazine 240. Fastening elements 210 have been introduced into the magazine 240, said fastening elements 210 being transported in a transporting direction 290 into a setting duct (not illustrated). The fastening elements 210 define a fastening direction 280 into the plane of the drawing, and so only the heads of the fastening elements 210 can be seen in FIG. 5. The fastening elements 210 are arranged in two rows, which are arranged one behind the other in a transverse direction 270 oriented perpendicularly to the transporting direction 290 and perpendicularly to the fastening direction 280. The magazine 240 transports the fastening elements 210 of the two rows alternately into the setting duct.

The magazine 240 comprises a magazine housing 250 and a transport duct 220 for guiding the two rows of fastening elements 210 into the setting duct. The transport duct 220 is movable back and forth in the transverse direction 270. Furthermore, the magazine 240 has a feeding element 260, which applies a force 265 in the transporting direction 290 to the fastening elements 210 in order to effect the transport of the fastening elements 210. For this purpose, the feeding element 260 has a contact face 261 for contact with only one of the plurality of rows of fastening elements 210. The feeding element 260 is part of a slider 241 that is movable in the transporting direction 290, and is guided in a guide rail 295. The guide rail 295 is part of the magazine housing 250 or is connected rigidly to the magazine housing 250. The feeding element 260 is in this case arranged in a manner offset in the fastening direction 280 with respect to the transport duct 220.

FIG. 4 illustrates a perspective view of a magazine 300. The magazine has a transport duct 310 for transporting fastening elements 320 in a transporting direction 330 to a setting duct. Furthermore, the magazine 300 comprises a guide rail 340 and a slider 350, which has a slide 360 guided on the guide rail 340 and is displaceable in the transporting direction 330 along the transport duct 310. A feeding spring (not shown), for example in the form of a roller spring, applies a force in the transporting direction 330 toward the setting duct to the slider 350. The slider has an actuating element 370, by means of which the slider 350 is shiftable manually counter to the transporting direction 330. An end region 380, remote from the setting duct, of the magazine comprises an end wall 390, which forms a stop for the slider 350.

FIGS. 5 to 8 illustrate the slider 350 in a perspective view (FIG. 5), in a front view (FIG. 6), in a plan view (FIG. 7), and in a side view (FIG. 8), in each case in a transporting position. FIGS. 9 to 12 illustrate the slider 350, by comparison, in each case in a transporting position, again in a perspective view (FIG. 9), in a front view (FIG. 10), in a plan view (FIG. 11), and in a side view (FIG. 12).

The slider 350 has a feeding element 400, which is pivotable about a pivot axis oriented with respect to the transport direction 330 between the transporting position and the passage position. A release spring (not shown) urges the feeding element 400 toward the passage position. In the transporting position, the feeding element 400 projects into the transport duct in order apply a force in the transporting direction 330 to the fastening elements 320. In the passage position, the feeding element 400 frees up the transport duct 310 for the fastening elements 320, such that the magazine 300 can be filled with further fastening elements. For latching in the transporting position, the slider 350 has a latching receptacle 410, in which the feeding element 400 latches when it is arranged in the transporting position. A latching spring (not shown) urges the feeding element 400 into the latching receptacle 410. The slider 350 comprises a stop element 420, by means of which the feeding element 400 is shiftable out of the latching receptacle 410 counter to a force of the latching spring when the stop element 420 strikes the stop formed by the end wall 390. The stop element 420 is connected rigidly to the feeding element 400. Furthermore, the slider 350 has an engagement lever 430, by means of which the feeding element 400 is pivotable manually from the passage position into the transporting position counter to a force of the release spring. The engagement lever 430 is connected rigidly to the feeding element 400.

FIG. 13 illustrates a perspective view of the feeding element 400. A release spring 440 in the form of a torsion spring urges the feeding element 400 toward the passage position and is supported on an inner side of the slider 350. As a result, any sliding of the release spring 440 on the magazine 300 is avoided, and so frictional resistance during the transport of the fastening elements 320 in the transport duct 310 is reduced. A latching spring 450 in the form of a compression spring urges the feeding element 400 into the latching receptacle 410 and is likewise supported on the slider 350.

In order to fill the magazine 300, first of all the slider 350 is displaced manually counter to the transporting direction 330 by means of the actuating element 370 until the stop element 420 strikes the end wall 390 and the feeding element 400 is advanced out of the latching receptacle 410 by the stop element 420 and into the passage position by the release spring 440. After the magazine has been filled with fastening elements 320, the feeding element is advanced manually into the transporting position by means of the engagement lever 430 and into the latching receptacle 410 by the latching spring 450. The feeding spring then pushes the slider 350 with the feeding element 400 counter to the fastening elements 320, to which a force in the transporting direction is then applied.

The invention has been described by way of a series of exemplary embodiments. The individual features of the various exemplary embodiments are applicable individually or in any desired combination with one another, provided that they are not contradictory. It should be noted that the driving-in apparatus according to the invention is also usable for other applications.

1. An apparatus for driving fastening elements into an underlying surface, the apparatus having a setting duct, an energy transmission element, which is movable in a fastening direction in the setting duct, for transmitting energy to each one of the fastening elements, and having a magazine, which has a transport duct for transporting the fastening elements in a transporting direction to the setting duct, wherein the magazine comprises a slider, which is displaceable in the transporting direction along the transport duct and has a feeding element, which is movable between a transporting position and a passage position, wherein the feeding element projects into the transport duct in the transporting position to apply a force in the transporting direction to the fastening elements, wherein the feeding element opens up the transport duct for the fastening elements in the passage position, and wherein the slider has a release spring, which urges the feeding element toward the passage position and is supported on the slider.

2. The apparatus as claimed in claim 1, wherein the slider has a latching receptacle, in which the feeding element latches when it is arranged in the transporting position.

3. The apparatus as claimed in claim 2, wherein the slider has a latching spring, which urges the feeding element into the latching receptacle.

4. The apparatus as claimed in claim 3, wherein the latching spring is supported on the slider.

5. The apparatus as claimed in claim 1, wherein the slider has an engagement lever, by which the feeding element is shiftable from the passage position into the transporting position.

6. The apparatus as claimed in claim 5, wherein the engagement lever is connected rigidly to the feeding element.

7. The apparatus as claimed in claim 1, wherein the slider has an actuating element, by which the slider is shiftable manually counter to the transporting direction.

8. The apparatus as claimed in claim 1, wherein the slider has a stop element, by which the feeding element is shiftable out of the latching receptacle.

9. The apparatus as claimed in claim 8, wherein the stop element is connected rigidly to the feeding element.

10. The apparatus as claimed in claim 8, wherein the magazine comprises an end region remote from the setting duct, said end region comprising a stop for the stop element.

11. The apparatus as claimed in claim 10, wherein the magazine has an end wall in the end region, said end wall forming the stop.

12. The apparatus as claimed in claim 1, wherein the feeding element is pivotable about a pivot axis between the transporting position and the passage position.

13. The apparatus as claimed in claim 1, wherein the feeding element is displaceable linearly between the transporting position and the passage position.

14. The apparatus as claimed in claim 1, wherein the transport duct opens into the setting duct by way of a mouth.

15. The apparatus as claimed in claim 1, wherein the apparatus has a feeding spring, which applies a force toward the setting duct to the feeding element.

16. The apparatus of claim 5, wherein the feeding element is manually shiftable from the passage position into the transporting position counter to a force of the release spring.

17. The apparatus of claim 8, wherein the feeding element is manually shiftable out of the latching receptacle counter to a force of the latching spring.

18. The apparatus as claimed in claim 9, wherein the magazine comprises an end region remote from the setting duct, said end region comprising a stop for the stop element.

19. The apparatus as claimed in claim 2, wherein the slider has an engagement lever, by which the feeding element is shiftable from the passage position into the transporting position.

20. The apparatus as claimed in claim 3, wherein the slider has an engagement lever, by which the feeding element is shiftable from the passage position into the transporting position.
